(19) United States
(12) Patent Application Publication
(10) Pub. No.: US 2009/0275474 A1
(43) Pub. Date: Nov. 5, 2009

(54) PESTICIDAL APPLICATIONS OF DIMETHYL CYANAMIDE

(75) Inventors: Rodrigo Rodriguez-Kabana, Auburn, AL (US); Anne E.V. Gorden, Auburn, AL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Metbro Distributing L.P., Fresno, CA (US)

(21) Appl. No.: 12/112,429

(22) Filed: Apr. 30, 2008

(51) Int. Cl. A01N 33/26; A01N 47/40; A01P 13/00; A01P 5/00

(52) U.S. Cl. 504/326; 514/609

(57) ABSTRACT

Dimethyl cyanamide is an active herbicide and nematicide.

### BACKGROUND OF THE INVENTION

This invention resides in materials and methods for crop protection, including both soil treatments or pre-emergence application and post-emergence foliar application, to control the growth of nematodes and weeds.

The agricultural industry relies on effective control of insects, plant pathogens, nematodes, and weeds, for bountiful and healthy crops. The control of certain forms of nematodes, for example, is an important factor in ensuring crop plant viability in the initial stages of crop growth and likewise for plant productivity and life span in both annual and perennial crops. Effective nematode control is particularly important in view of the ability of nematodes to persist in soil after crop removal.

Known methods for controlling nematodes include crop rotation, fallowing, the use of nematode-resistant crops, and soil fumigation. Of these, soil fumigation is the method that is the most economically feasible and the most widely used, and methyl bromide is the most widely used soil fumigant. Methyl bromide is a highly effective broad spectrum pesticide that is used both in both pre-harvest and post-harvest fumigation. A difficulty with methyl bromide however is its volatility, which results in the release of a significant amount of the chemical to the atmosphere when applied to soil. This reduces the amount of methyl bromide available for pesticidal action in the soil and also causes depletion of the ozone layer due to the reaction of ozone with the bromine atoms that are released when the methyl bromide undergoes photo-oxidation. The high volatility of methyl bromide also limits the effectiveness of this fumigant in heavy soils.

Cyanamide, a term that is used to designate both hydrogen cyanamide and calcium cyanamide, is used in Europe as an herbicide and in various parts of the world as a plant growth regulator. The convenience of using liquid formulations has increasingly made it a favored material, and research has shown hydrogen cyanamide to be the active ingredient of both cyanamide preparations. From its introduction in the 1950's, hydrogen cyanamide was used as a pre-emergence herbicide and a defoliant. The effectiveness of hydrogen cyanamide was attributable at least in part to the action of moist soil on plants in hydrolyzing calcium cyanamide to hydrogen cyanamide, which was not totally understood at the time. In the environment, hydrogen cyanamide decomposes to urea, followed by additional breakdown to ammoniacal forms of nitrogen and carbon dioxide. These metabolites become plant nutrients with their occurrence mediated by biological organisms and/or physical processes.

U.S. published patent applications 2007/0092581 and 2007/116781 describe formulations of hydrogen cyanamide in combination with a short-chain water-soluble alkanoic carboxylic acid that demonstrate improved pesticidal activity. The preferred carboxylic acid is propionic acid.

### BRIEF SUMMARY OF THE INVENTION

According to the invention herein, it has been determined that dimethyl cyanamide has herbicidal and nematicidal properties, both when applied to or incorporated into the soil and when applied to vegetation in a post-emergence foliar application.

Consequently, this invention relates to a method of controlling undesirable vegetation (weeds) by applying to the vegetation or to the locus thereof (including preemergence application) a herbicidal effective amount of dimethyl cyanamide. In another embodiment the invention comprises a method of controlling nematodes by applying to the nematodes, to the locus of the nematodes, or to a locus where control of nematodes is desired, a nematicidally effective amount of dimethyl cyanamide.

The invention further comprises herbicidal and nematicidal compositions comprising a herbicidally or nematicidally effective amount (respectively) of dimethyl cyanamide and a carrier or diluent suitable for inclusion in agricultural compositions.

### BRIEF DESCRIPTION OF THE DRAWINGS

FIG. 1 depicts Rotylenchulus reniformis (a parasiticidal nematode) content in the soil at the start of a first test for control of nematodes by dimethyl cyanamide and by hydrogen cyanamide at various delivery rates.

FIG. 2 depicts microbivorous (beneficial) nematode content in the soil at the start of the same test.

FIG. 3 depicts Rotylenchulus reniformis nematode content in the soil at the end of the same test.

FIG. 4 depicts microbivorous nematode content in the soil at the end of the same test.

FIG. 5 depicts Rotylenchulus reniformis nematode content in the root system of soybean plants at the end of the same test.

FIG. 6 depicts the shoot weight of the soybean plants at the end of the same test.

FIG. 7 depicts Rotylenchulus reniformis nematode content in the soil at the start of a second test for control of nematodes by dimethyl cyanamide and by diisopropyl cyanamide at various delivery rates.

FIG. 8 depicts microbivorous (beneficial) nematode content in the soil at the start of the second test for control of nematodes.

FIG. 9 depicts the weight of fresh cotton plant shoots at the end of the second test for nematodes.

FIG. 10 depicts the root condition of the cotton plants at the end of the second test for nematodes.

FIG. 11 depicts total population of four weed species in a test of dimethyl cyanamide and of hydrogen cyanamide for herbicidal activity, 11 days after delivery.

FIG. 12 depicts total weed population in the same test 32 days after delivery.

FIG. 13 depicts total weed population of four weeds in a test of dimethyl cyanamide alone and in combination with the herbicide EPTC, 6 days after delivery.

FIG. 14 depicts total weed population in the same test 47 days after delivery.

FIG. 15 depicts total weed population in the same test 62 days after delivery.

### DETAILED DESCRIPTION OF THE INVENTION

According to the invention herein, it has been determined that dimethyl cyanamide has herbicidal and nematicidal properties, both when applied to or incorporated into the soil and when applied in a postemergence foliar manner.

Consequently, in one embodiment this invention relates to a method of controlling undesirable vegetation (weeds) by applying to the vegetation or to the locus thereof (including preemergence application) a herbicidally effective amount of dimethyl cyanamide. In another embodiment the invention comprises controlling nematodes by applying to the nematodes, to the locus of the nematodes, or to a locus where control of nematodes is desired, a nematicidally effective amount of dimethyl cyanamide. In further embodiments the invention comprises herbicidal and nematicidal compositions comprising a herbicidally or nematicidally effective amount (respectively) of dimethyl cyanamide and a carrier or diluent suitable for such compositions.

Dimethyl cyanamide, [(CH₃)₂]N—C≡N, is known as a solvent (see, e.g., U.S. Pat. No. 6,469,217), a chemical reagent (see, e.g., U.S. Pat. No. 5,373,008), particularly for production of 1,1,3,3-tetramethylguanidine (see, e.g. U.S. Pat. No. 6,262,304 and British patent 1,267,318) and for use in resins (see, e.g., U.S. Pat. No. 7,255,904). However, it has never been even suggested that this compound might have any pesticidal properties.

As shown by the data that follows, dimethyl cyanamide has been found to possess both herbicidal and nematicidal properties, both when applied to or incorporated into, soil and when applied foliar postemergence.

Compositions of the present invention will contain a herbicidally or nematicidally effective amount of dimethyl cyanamide and at least one diluent or carrier suitable for use in agricultural pesticidal compositions. Such compositions optionally will also contain adjuvants or diluents such as formulating aids, buffers and other stabilizers, solubilizing agents, dispersing agents, and/or crop nutrients. These additives are well known in the agricultural formulations industry and readily available from suppliers of agricultural chemicals.

Compositions of the invention may be in liquid or solid form and may be for immediate release, controlled release or extended release of the dimethyl cyanamide.

Compositions containing dimethyl cyanamide include both dilute compositions that are ready for immediate use, and concentrated compositions that typically are diluted before use, usually with water. Preferably the compositions contain from 0.01% to 90% by weight of the dimethyl cyanamide. Dilute compositions ready for use preferably contain from 0.01 to 2% of that ingredient, while concentrated compositions may contain from 20 to 90% of it, although from 20 to 70% is usually preferred.

Solid compositions of the invention may be in the form of granules or dusting powders wherein the active ingredient is mixed with a finely divided solid diluent, e.g., kaolin, bentonite, kieselguhr, talc, or Fuller's earth. Solid diluents for use in the compositions of the invention should not contain a carrier or diluent that is acidic or alkaline. The compositions may also be in the form of wettable or dispersible powders or grains, comprising a wetting agent to facilitate the dispersion of the powder or grains in liquid. Solid compositions in the form of a powder may be applied as foliar dusts. Wettable powders are in the form of finely divided particles which disperse readily in water or other liquid carriers. The particles contain the active ingredient retained in a solid matrix. Solid compositions may also be in the form of tablets of various shapes. Typical solid matrices for solid compositions in general include Fuller's earth, kaolin clays, silicas and other readily wettable organic or inorganic solids. Wettable powders normally contain about 5% to about 95% of the active ingredient plus a small amount of wetting, dispersing, or emulsifying agent.

Liquid compositions may comprise a solution, dispersion or emulsion of dimethyl cyanamide in water, optionally containing a surface-active agent, or may comprise a solution or dispersion of it in a water-immiscible organic solvent which is dispersed as droplets in water. Surface-active agents may be of the cationic, anionic, or non-ionic type. Cationic agents include, for example, quaternary ammonium compounds. Suitable anionic agents include soaps; salts or aliphatic mono esters of sulfuric acid, for example sodium lauryl sulfate; and salts of sulfonated aromatic compounds, for example sodium dodecylbenzenesulfonate, sodium, calcium, and ammonium lignosulfonates, butylnaphthalene sulfonate, and a mixture of the sodium salts of diisopropyl and triisopropylnaphthalenesulfonic acid. Suitable non-ionic agents include the condensation products of ethylene oxide with fatty alcohols such as oleyl alcohol and cetyl alcohol, or with alkylphenols such as octyl- or nonyl-phenol or octyl-cresol. Other non-ionic agents include the partial esters derived from long chain fatty acids and hexitol anhydrides, for example sorbitan monolaurate; the condensation products of the partial ester with ethylene oxide; and the lecithins.

Aqueous solutions, emulsions or dispersions may be prepared by dissolving the dimethyl cyanamide in water or an organic solvent optionally containing wetting or dispersing agent(s) and then, when organic solvents are used, adding the mixture so obtained to water optionally containing wetting or dispersing agent(s). Suitable organic solvents include, for example, ethylene dichloride, isopropyl alcohol, propylene glycol, diacetone alcohol, toluene, kerosene, methylnaphthalene, the xylenes and trichloroethylene.

Compositions for use in the form of aqueous solutions, emulsions or dispersions are generally supplied in the form of a concentrate containing a high proportion of the dimethyl cyanamide, and the concentrate is then diluted with water before use. The concentrates are usually required to withstand storage for prolonged periods and after such storage, to be capable of dilution with water to form aqueous preparations that remain homogeneous for a sufficient time to enable them to be applied by conventional spray equipment. Such concentrates conveniently contain 20-90%, preferably 20-70%, by weight of dimethyl cyanamide. Dilute preparations ready for use may contain varying amounts of the active ingredient(s) depending upon the intended purpose; amounts of 0.01% to 10.0% and preferably 0.1% to 2%, by weight of active ingredient(s) are normally used. Emulsifiable concentrates are homogeneous liquid compositions dispersible in water or other liquid, and may consist entirely of the active compound with a liquid or solid emulsifying agent, or may also contain a liquid carrier, such as xylene, heavy aromatic naphthas, isophorone and other nonvolatile organic solvents.

Controlled-, sustained- or extended-release compositions may be in the form of tablets or the like containing an agent that serves to control the release of the dimethyl cyanamide into the surrounding environment. Such compositions may alternatively be in the form of microcapsules. Microcapsules are typically droplets or solutions of the active material enclosed in an inert porous shell which allows escape of the enclosed material to the surrounds at controlled rates. Encapsulated droplets are typically about 1 to 50 microns in diameter. The enclosed material typically constitutes about 50 to 95% of the weight of the capsule, and may include solvent in addition to the active compound. Shell or membrane materials include natural and synthetic rubbers, cellulosic materials, styrene-butadiene copolymers, polyacrylonitriles, polyacrylates, polyesters, polyamides, polyureas, polyurethanes and starch xanthates.

Each of the above formulations can be prepared as a package containing the dimethyl cyanamide together with other ingredients of the formulation (diluents, emulsifiers, surfactants, etc.). The formulations can also be prepared by a tank mix method, in which the ingredients are obtained separately and combined at the grower site.

The rate of application of the dimethyl cyanamide will depend on a number of factors including, for example, the identity of the plants whose growth is to be inhibited or of the nematodes that are to be controlled, the formulations selected for use and whether the compound is to be applied for foliage or root uptake. As a general guide, however, an application rate of from about 50 to about 1000 pounds per acre is suitable, preferably from about 50 to about 500 lb./acre, and most preferably from about 50 to about 300 lb./acre, for both application to or incorporation into soil and for application by postemergence foliar spraying.

The compositions of the invention may comprise, in addition to dimethyl cyanamide, one or more compounds not of the invention but which possess biological activity. Accordingly in yet a still further embodiment the invention provides a herbicidal composition comprising a mixture of a herbicidally or nematicidally effective amount of dimethyl cyanamide together with a pesticidally effective amount of at least one other pesticidal compound. The other pesticide may be any herbicide or nematicide other than dimethyl cyanamide, or it may be another type of pesticide entirely, such as an insecticide, fungicide, or microbiocide.

It should be noted that, like hydrogen cyanamide, dimethyl cyanamide will also serve in part as a fertilizer due to its release of nitrogen-containing moieties.

The types of soils in which the compositions of this invention can be effective include sandy soils, loamy soils, clays, silt, high organic matter soils, and combinations such as sandy loam, silty loam, sandy clay, and the like. When the compositions are used for controlling undesirable vegetation, effective results can be achieved with both pre-emergence application (application directly to the soil before the undesirable vegetation emerges from the soil surface) and post-emergence application (application directly to the undesirable vegetation that has already emerged). Useful methods of application include broadcast or localized spraying, drip irrigation or other forms of irrigation, and any of these methods followed by soil tilling. The application rate of the dimethyl cyanamide to the soil can vary over a wide range, as discussed above. The optimal application rates will depend on the crop to be protected, the nature of the infestation (whether it be nematode or weed infestation), the stage of growth of the crop and of the infestation, and the manner in which application is made, i.e., whether by spraying, irrigation, or other means. For best results in controlling nematodes, the rate of application of dimethyl cyanamide will range from about 50 to about 500, preferably from about 50 to about 250, pounds per acre. For best results in controlling weeds and other undesirable vegetation, the rate of application of hydrogen cyanamide will range from about 50 to about 1,000, and preferably from about 50 to about 500, lb./acre.

### EXAMPLES

The following are representative examples of the invention, i.e. the nematicidal and herbicidal activity of dimethyl cyanamide. However, they are not intended to demonstrate the limits of this invention, but are only illustrative in nature.

### Nematicidal Activity

### Example 1

### Dimethyl Cyanamide Vs. Hydrogen Cyanamide

Hydrogen cyanamide (Dormex® formulation, Dormex Corp.) and dimethyl cyanamide (Aldrich) were delivered in aqueous preparations (1.25% active ingredient) (A.I.) prepared immediately before use by diluting in demineralized water while stirring with a magnetic stirrer. Each compound was delivered at rates of 0, 25, 50, 75, 100, 150, and 200 mg A.I./kg soil—equivalent to 0, 50, 100, 150, 200, 300, and 400 lbs A.I./acre.

Each treatment was delivered by drenching the compound in 100 mL aqueous volume onto the soil surface in pots (10-cm diam.; PVC) containing 1 kg soil. The soil (silt loam; pH 6.2; cec<10 meq/100 gm soil; org. matter<1.0%) was from a cotton field severely infested with the reniform nematode (Rotylenchulus reniformis). Immediately after treatment the pots were covered with a thick (1.5 mil) clear low density polyethylene bag held tight against the outer wall of the pot by a rubber band. Eleven days after application the bags were removed and soil samples were taken from every pot (experimental unit) for nematological analysis (salad bowl incubation technique). Each pot was then planted with five seeds of nematode-susceptible “Hutcheson” soybean (glycine max) and the resulting plants were grown for eight weeks, at which time the plants were removed and soil samples were taken from each pot. Final root and soil nematode populations were determined and plant growth parameters (number & height of plants, weights of shoots and roots, root condition indices) were recorded.

Major pests: The reniform nematode [Rotylenchulus reniformis].

Experimental design: Randomized complete block with seven replications/treatment.

Statistical analyses: ANOVA and Fischer's least significant difference [FLSD] at p 0.05. Regression analyses.

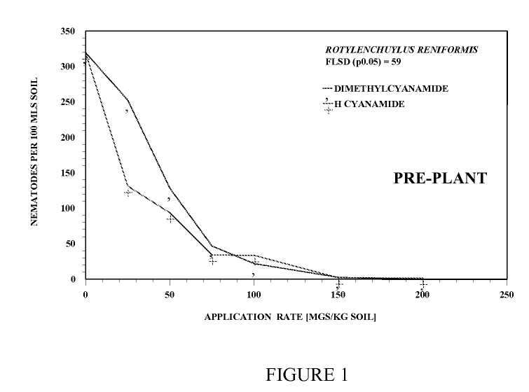

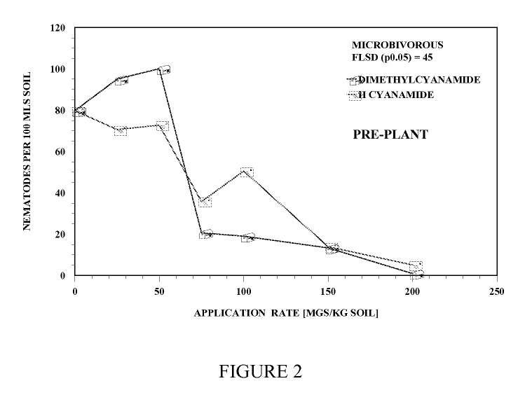

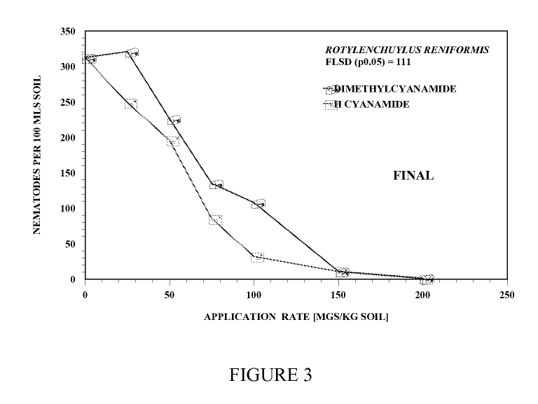

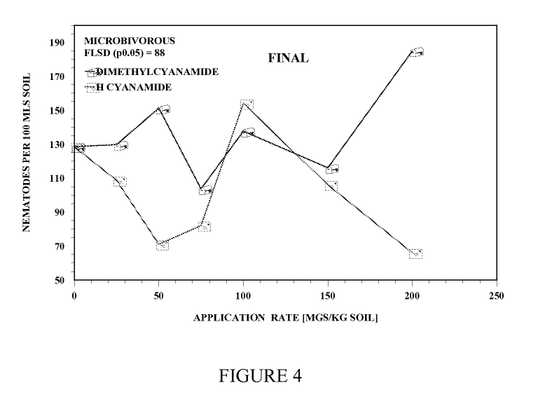

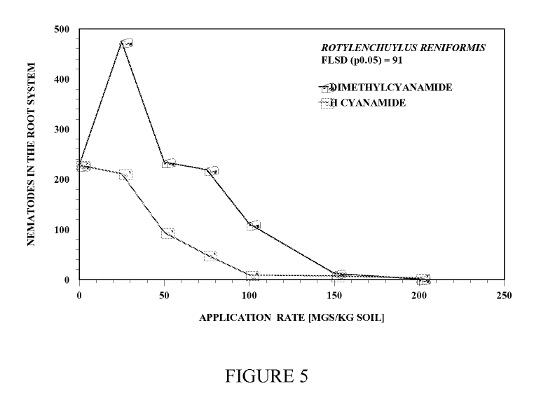

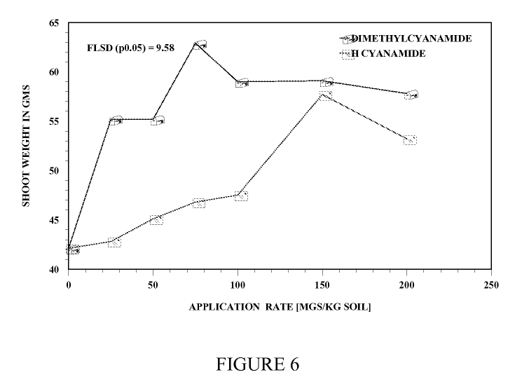

Results: The results are shown in FIGS. 1-6. Applications of hydrogen cyanamide and dimethyl cyanamide were nematicidal, resulting in suppression or elimination of the reniform nematode in soil and soybean roots. Reductions of soil populations of the nematode could be described by a logistical dose-response model. Soil populations of dorylaimida (predatory, not plant parasitic nematodes) were similarly reduced by treatments with the chemicals; however, beneficial microbivorous nematodes were not significantly affected by the chemicals.

Root populations of the reniform nematode were lower in plants resulting from hydrogen cyanamide treatments than in those from the dimethyl compound. Treatments with dimethyl cyanamide resulted generally in soybean plants that were taller and with heavier shoots and roots than those from pots treated with hydrogen cyanamide.

The data indicate that dimethyl cyanamide is a powerful nematicide, possibly much more so than hydrogen cyanamide. This is particularly evident when the data are considered in terms of the rates of cyanamide anion applied. The ratio of molecular weights of dimethyl cyanamide:hydrogen cyanamide is 70:42, so that a given weight of hydrogen cyanamide contains approximately 1.66 times as much cyanamide (NCN group) as the dimethyl cyanamide. Nevertheless, as shown in the figures, delivery of dimethyl cyanamide at the same rate (kg/ha) as hydrogen cyanamide produced very similar results overall, so that it would appear that dimethyl cyanamide can be considered more effective as a nematicide than hydrogen cyanamide.

### Example 2

### Dimethyl Cyanamide Vs. Diisopropyl Cyanamide

Dimethyl cyanamide and diisopropyl cyanamide (both obtained from Aldrich) were delivered in aqueous preparations (1.25% active ingredient) (A.I.) prepared immediately before use by diluting in demineralized water while stirring with a magnetic stirrer. Diisopropyl cyanamide was included in the test, although not known to be a nematicide, in order to assess whether other lower alkyl cyanamides would possess nematicidal properties. Each compound was delivered at rates of 0, 20, 40, 60, 80, 100, and 150 mgs. A.I./kg soil—equivalent to 0, 50, 100, 150, 200, 300, and 400 lbs A.I./acre.

Each treatment was delivered by drenching in 100 mL aqueous volume onto the soil surface in pots (10-cm diam.; PVC) containing 1 kg soil. The soil (silt loam; pH 6.2; cec<10 meq/100 gm soil; org. matter<1.0%) was from a cotton field severely infested with the reniform nematode [Rotylenchulus reniformis]. Immediately after treatment the pots were covered by a thick (1.5 mil) clear low density polyethylene bag held tight against the outer wall of the pot by a rubber band. Eleven days after application the bags were removed and soil samples were taken from every pot (experimental unit) for nematological analysis (salad bowl incubation technique). Each pot was then planted with five seeds of nematode-susceptible “Rowden” cotton (Gossipyum hirsutum) and the resulting plants were grown for eight weeks, at which time the plants were removed and soil samples were taken from each pot. Final root and soil nematode populations were determined and plant growth parameters (number and height of plants, weights of shoots and roots, root condition indices) were recorded.

Major pests: The reniform nematode [Rotylenchulus reniformis].

Experimental design: Randomized complete block with seven replications/treatment.

Statistical analyses: ANOVA and Fischer's least significant difference [FLSD] at p

0.05. Regression analyses.

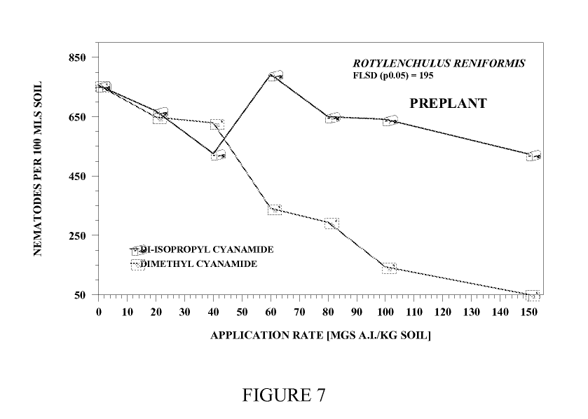

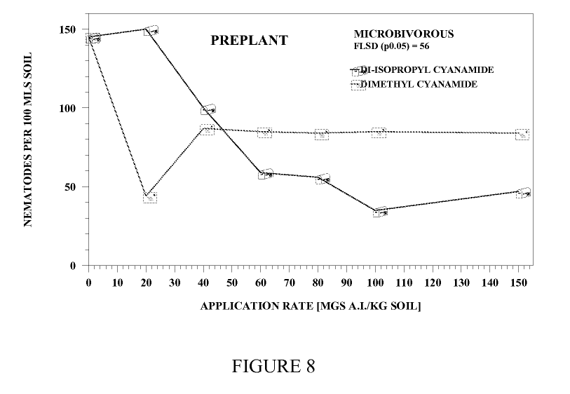

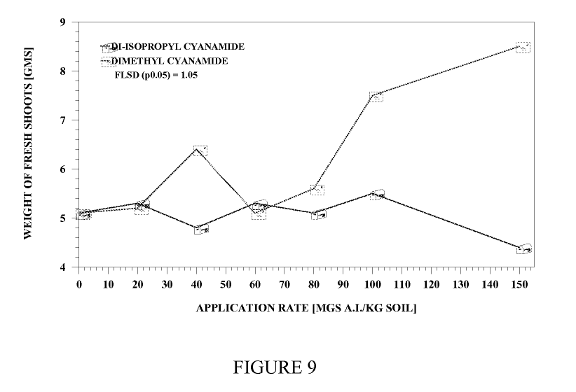

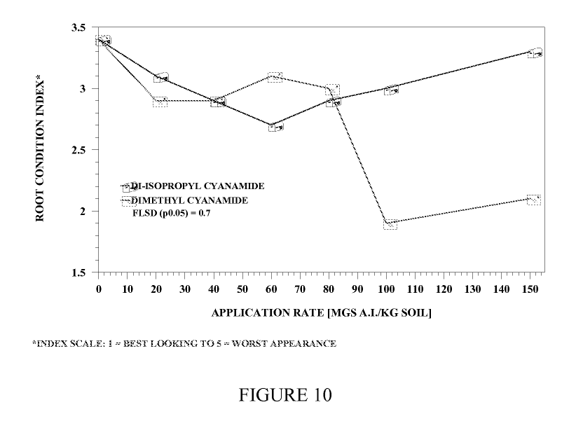

Results: The results are shown in FIGS. 7-10. In sharp contrast with applications of diisopropyl cyanamide, those with dimethyl cyanamide were nematicidal, resulting in suppression or elimination of the reniform nematode in soil. For the two highest rates there was concomitant increase in plant heights and in shoot and root weights. The number of cotton plants/pot was higher in pots treated with dimethyl cyanamide than with those that received diisopropyl cyanamide. Root health as indicated by data on root appearance indices was markedly improved by the two highest rates of dimethyl cyanamide treatments but not by any rate of diisopropyl cyanamide. Soil populations of dorylaimida (predatory, not plant parasitic nematodes) and beneficial microbivorous nematodes were either reduced or not affected by treatments with the chemicals.

The data indicate that dimethyl cyanamide is a powerful nematicide but that diisopropyl cyanamide is not.

### Example 3

### Herbicidal Activity

Hydrogen cyanamide and dimethyl cyanamide were delivered in aqueous 5% solutions prepared immediately before use by diluting in demineralized water while stirring with a magnetic stirrer. Both chemicals were obtained from Aldrich. Each compound was delivered at rates of 0, 100, 200, 300, 400, 600, and 800 mgs. A.I./kg soil—equivalent to 0, 200, 400, 600, 800, 1200, and 1600 lbs A.I./acre.

Each treatment was delivered by drenching in 100 mL aqueous volume onto the soil surface in pots [10-cm diam.; PVC] containing 1 kg soil. The soil was from a cotton field [silt loam; ph 6.2; cec<10 meq/100 gm soil; org. matter<1.0%]. Immediately after treatment the pots were covered by a thick [1.5 mil] clear low density polyethylene bag held tight against the outer wall of the pot by a rubber band. Eleven days after application the bags were removed. Weed counts were taken from each pot [experimental unit] at 11, 19, 26 and 32 days after application of the treatments.

Major pests: Yellow nutsedge [Cyperus esculentus], crabgrass [Digitaria sanguinalis], sicklepod [Senna obtusifolia], morningglory [Ipomoea spp.], and other annual weeds.

Experimental design: Randomized complete block with seven replications/treatments.

Statistical analyses: ANOVA and Fischer's least significant difference [FLSD] at p 0.05. Regression analyses.

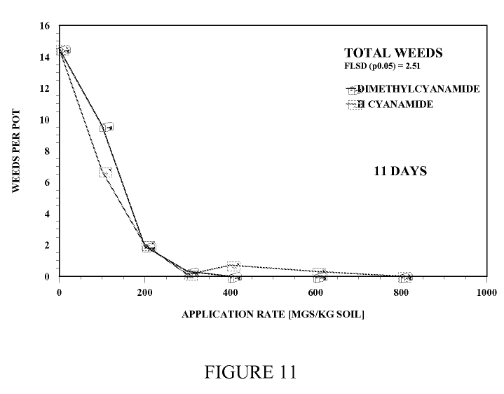

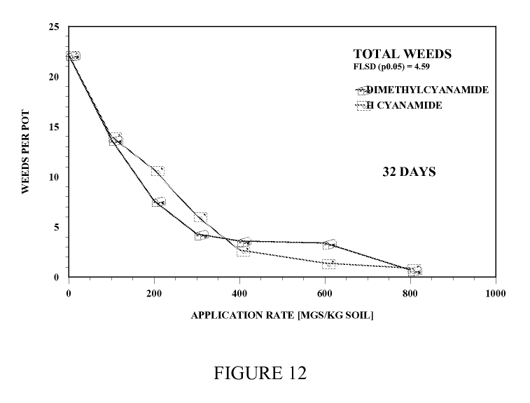

Results are shown in FIGS. 11-12. Applications of both hydrogen cyanamide and dimethyl cyanamide were herbicidal against all weed species tested. For both compounds and all species but yellow nutsedge, reductions in weed populations could be described by a logistical dose response model. Thus, most reductions in weed numbers were observed for rates [r] in the range 100<r≦400 mgs/kg soil. Control of yellow nutsedge required rates >400 mgs.

With one exception (sicklepod) dimethyl cyanamide was superior to hydrogen cyanamide as a herbicide. This became evident when dose-response was expressed in terms of mg of CN added to the soil. The data indicate that dimethyl cyanamide possesses considerable herbicidal activity equivalent to or better than that shown by hydrogen cyanamide.

### Example 4

### Herbicidal Activity in Combination with EPTC

Dimethyl cyanamide was delivered in a 5% aqueous solution. The herbicide EPTC [ethyl n-propyl thiocarbamate] was delivered in an aqueous emulsion containing 0.1192% A.I. Both formulations were prepared immediately before use by diluting or mixing [a concentrated formulation?] in demineralized water while stirring with a magnetic stirrer. The dimethyl cyanamide was obtained from Aldrich. The EPTC used was a commercial formulation [Eptam® herbicide, Gowan].

Dimethyl cyanamide was applied at rates of 0, 50, 100, 200, 300, and 400 mg A.I./kg soil—equivalent to 0, 100, 200, 400, 600, and 800 lbs A.I./acre, respectively. EPTC was delivered at 0 and 3.576 mg/kg soil, equivalent to 0 and approximately 7 lbs. A.I./acre. All possible combinations of the two compounds at their corresponding rates were included in the experiment.

Each treatment was delivered by drenching in 100 mL aqueous volume onto the soil surface in pots [10-cm diam.; PVC] containing 1 kg soil. The soil was from a cotton field [silt loam; ph 6.2; cec<10 meq/100 gm soil; org. matter<1.0%1. Immediately after treatment the pots were covered by a thick [1.5 mil] clear low density polyethylene bag held tight against the outer wall of the pot by a rubber band. Six days after application the bags were removed. Weed counts were taken from each pot [experimental unit] at 6, 12, 17, 47, and 62 days after application of the treatments.

Major pests: Yellow nutsedge [Cyperus esculentus], crabgrass [Digitaria sanguinalis], sicklepod [Senna obtusifolia], morningglory [Ipomoea spp], and other annual weeds.

Experimental design: Randomized complete block with seven replications/treatment.

Statistical analyses: ANOVA and Fischer's least significant difference [FLSD] at p 0.05. Regression analyses.

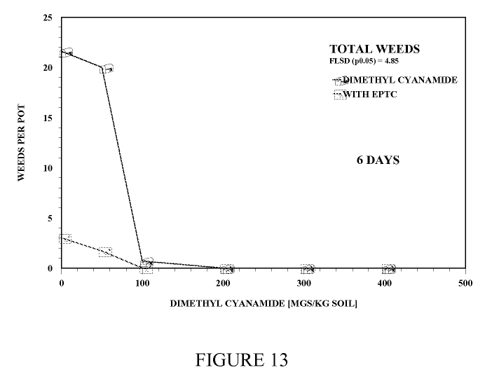

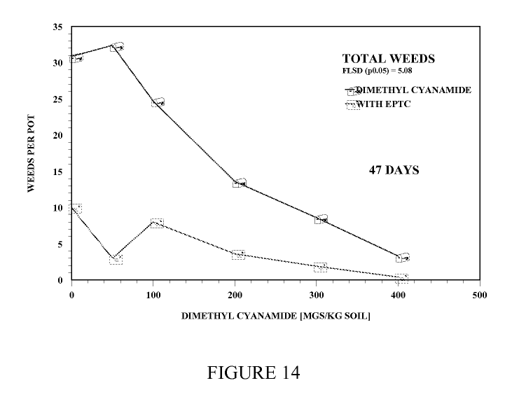

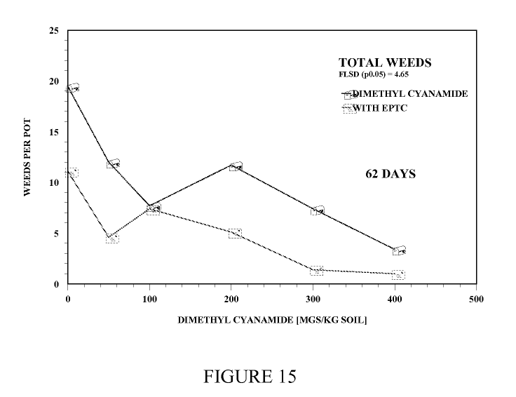

The results are shown in FIGS. 13-15. EPTC and dimethyl cyanamide were compatible for herbicidal activity. The inclusion of EPTC in the dimethyl cyanamide treatments resulted in considerable enhancement in herbicidal activities. Although the herbicidal activity of dimethyl cyanamide was almost “masked” by that of EPTC during the initial counts, some enhancement of EPTC by the dimethyl cyanamide was evident for some weed species in later counts.

The data suggest that combinations of EPTC with dimethyl cyanamide are feasible and result in enhancement in herbicidal activities compared with the individual use of the compounds.

The foregoing descriptions are offered primarily for purposes of illustration. Further modifications, variations and substitutions that still fall within the spirit and scope of the invention will be readily apparent to those skilled in the art. All such modifications coming within the scope of the appended claims are intended to be included therein.

All publications, patents, and patent applications cited herein are hereby incorporated by reference in their entirety for all purposes, except to the extent inconsistent with the disclosure herein.

What is claimed is:

1. A method of controlling undesirable vegetation by applying to the vegetation or to the locus thereof a herbicidally effective amount of dimethyl cyanamide.

2. A method according to claim 1 in which the dimethyl cyanamide is applied in the presence of a crop.

3. A method according to claim 1 in which the dimethyl cyanamide is applied prior to the emergence of a crop.

4. A method according to claim 1 in which the dimethyl cyanamide is applied in the form of a liquid composition containing dimethyl cyanamide.

5. A method according to claim 4 in which the dimethyl cyanamide is applied in the form of an aqueous composition containing dimethyl cyanamide.

6. A method according to claim 1 in which the dimethyl cyanamide is applied at a rate of from about 50 to about 1000 lb/acre.

7. A method according to claim 1 in which the dimethyl cyanamide is applied at a rate of from about 50 to about 500 lb/acre.

8. A method according to claim 1 in which the dimethyl cyanamide is applied at a rate of from about 50 to about 300 lb/acre.

9. A method of controlling nematodes by applying to the nematodes, to the locus of the nematodes, or to a locus where control of nematodes is desired, a nematicidally effective amount of dimethyl cyanamide.

10. A method according to claim 9 in which the dimethyl cyanamide is applied in the presence of a crop.

11. A method according to claim 10 in which the crop is soybeans.

12. A method according to claim 9 in which the crop is cotton.

13. A method according to claim 9 in which the dimethyl cyanamide is applied prior to emergence of a crop.

14. A method according to claim 9 in which the dimethyl cyanamide is applied in the form of a liquid composition containing dimethyl cyanamide.

15. A method according to claim 14 in which the dimethyl cyanamide is applied in the form of an aqueous composition containing dimethyl cyanamide.

16. A method according to claim 9 in which the dimethyl cyanamide is applied at a rate of from about 50 to about 500 lb/acre.

17. A method according to claim 9 in which the dimethyl cyanamide is applied at a rate of from about 50 to about 250 lb/acre.

18. A herbicidal composition comprising a herbicidally effective amount of dimethyl cyanamide and an agriculturally acceptable diluent or carrier.

19. A nematicidal composition comprising a nematicidally effective amount of dimethyl cyanamide and an agriculturally acceptable diluent or carrier.
